(19) United States
(12) Patent Application Publication
(10) Pub. No.: US 2017/0210064 A1
(43) Pub. Date: Jul. 27, 2017

(54) APPARATUS AND METHODS FOR PRINTING THREE DIMENSIONAL OBJECTS

(71) Applicant: Auckland UniServices Limited, Auckland (NZ)

(72) Inventors: Kean Chin Aw, Henderson (NZ); Timothy Giffney, Katikati (NZ); Matthew John Jarvis Evans, Remuera (NZ); Reuben John Finch, Parnell (NZ)

(21) Appl. No.: 15/006,371

(22) Filed: Jan. 26, 2016

(51) Int. Cl. B29C 67/00; B29C 35/08; B29C 47/92

(52) U.S. Cl. CPC B29C 67/007; B29C 47/92; B29C 35/0805; B33Y 10/00

(57) ABSTRACT

3D printing apparatus and methods involving a reservoir configured to store at least one photopolymer material for printing three-dimensional objects, a material dispensing head in fluid connection with the reservoir, one or more peristaltic pump(s) controlling transport of material from the reservoir to the material dispensing head, a control system controlling operation of the peristaltic pump(s), and a radiation source for curing the material. Pulsatility of the flow output from said peristaltic pump(s) is smoothed using a compensation procedure.

### FIELD OF THE INVENTION

The present invention relates to methods and apparatus for additive manufacturing and/or three-dimensional (3D) printing of 3D objects.

### BACKGROUND TO THE INVENTION

Known 3D printing technology include stereo-lithography (STL), which makes use of the lithographic technology perfected in the semiconductor industry and applied it to a photo-curing resin. A laser is scanned selectively across a bath of photopolymer resin curing particular areas of the surface. The level of the uncured resin is increased slightly and the process repeated. While STL produces good detail rendition, multi-material printing is challenging and impractical as the entire resin bath needs to be changed, and cross-contamination issues.

Another known rapid prototyping technology is fused deposition modelling (FDM), which makes use of a heated thermoplastic extruded directly onto a print bed. Software control is used to divide an object into many fine threads that are extruded individually in layers to manufacture the part. As the thermoplastic cools it hardens into a functional part. However, thermoplastic printing processes typically involve temperatures in excess of 200° C., making them incompatible with many materials, and ‘smart’ printed objects.

A need exists for a rapid prototyping machine that is capable of 3D printing specially prepared polymer materials as desired, which would, for example, allow the printing of smart materials or components such as sensors, actuators, etc., and/or the implementation of smart components within a printed macro-scale object.

One particular area of interest is the rapid prototyping and rapid production of microelectromechanical (MEMS) devices. Traditionally, the production of MEMS devices is based on a combination of additive and subtractive machining on the surface of silicon wafers. These wafers are then combined together to create a functioning micro scale device. The process required highly specialized, accurate equipment. Once the specialised equipment and tooling has been developed, there is typically very little flexibility in further customisation of the machinery and processing. Accordingly, the ability to 3D print MEMS devices would offer a flexible and low cost platform compared to the expense of current MEMS manufacturing processes.

However, a major challenge in adapting 3D printing for MEMS fabrication lies in identifying materials and methods which are mechanically and chemically compatible with a range of materials required for printing smart devices.

It is an object of the present invention to provide 3D printing methods and apparatus that go some way to addressing one or more of the disadvantages above, or at least to provide the public with a useful choice.

In this specification where reference has been made to patent specifications, other external documents, or other sources of information, this is generally for the purpose of providing a context for discussing the features of the invention. Unless specifically stated otherwise, reference to such external documents is not to be construed as an admission that such documents, or such sources of information, in any jurisdiction, are prior art, or form part of the common general knowledge in the art.

### SUMMARY OF THE INVENTION

In one aspect, the present invention relates to a method for printing three-dimensional objects comprising:
providing at least one material printing three-dimensional objects in at least one reservoir,
transporting said material from said reservoir to at least one material dispensing head via one or more peristaltic pump(s), each said peristaltic pump comprising rollers driven by a motor to periodically compress a pump tubing to move said material through said pump tubing, wherein said motor is controlled by a control system,
depositing said material from said dispensing head, and
curing said deposited material with radiation.

In one embodiment, the entire printing method is performed at ambient temperature.

In another embodiment, the method is for printing three dimensional objects including a plurality of materials, the method further comprising providing multiple materials from multiple reservoirs, and transporting each material to a different dispensing head via one or more peristaltic pump(s).

In another embodiment, the method is for printing three dimensional objects including a plurality of materials, the method further comprising:
providing a first material from said reservoir,
transporting said first material from said reservoir to said material dispensing head via said peristaltic pump(s),
depositing said first material from said dispensing head,
curing said deposited first material with radiation,
providing a second material from said reservoir or from a second reservoir,
replacing one or more of:
   a) said pump tubing inside said peristaltic pump(s),
   b) fluid connection(s) between said reservoir and said peristaltic pump(s),
   c) fluid connection(s) between said peristaltic pumps) and said dispensing head,
   d) a dispensing nozzle of said dispensing head,
for use with said second material,
transporting said second material from said reservoir or said second reservoir to said material dispensing head via one or more peristaltic pump(s),
depositing said second material from said dispensing head, and
curing said deposited second material with radiation.

In another embodiment, said control system receives positional data related to said motors) of the peristaltic pump(s), wherein the control system varies the speed of rotation of the motor(s) to maintain a desired output flow rate from said peristaltic pump(s).

In another embodiment, said control system increases the speed of rotation of the motor at intervals where the pump tubing is uncompressed by said rollers, such that the pulsatility of the flow output from said peristaltic pump(s) is smoothed, and said desired output flow rate is maintained.

In another embodiment, said control system receives positional data related to said motor(s) of the peristaltic pump(s), and wherein the control system varies the speed of rotation of the motor(s) by increasing the speed of rotation of the motor(s) at intervals where the pump tubing is uncompressed by said rollers, to maintain a desired output flow rate from said peristaltic pump(s).

In another embodiment, each peristaltic pump is driven by a stepper motor, the method further comprising calibration steps of:
characterizing flow output of each peristaltic pump by determining periods of reduced flow,
determining one or more compensation parameters as the increase in the steps of said stepper motor required to maintain flow output during said periods of reduced flow,
wherein said control system applies said compensation parameter(s) to each pump to increase the steps of said stepper motor during said predetermined periods of reduced flow as characterized, such that a desired output flow rate from each peristaltic pump is maintained.

In another embodiment, material from said reservoir is transported to said material dispensing head via multiple pumps connected in parallel with each other,
wherein each pump transports material from said reservoir to said dispensing head, and
wherein the pumps operate out of phase with each other.

In another embodiment, material from said reservoir is transported to said material dispensing head via two pumps operating 30 degrees out of phase with each other.

In another embodiment, each peristaltic pump is driven by a stepper motor, and wherein the method further comprises tracking the absolute position of the stepper motor of each pump, to maintain the pumps out of phase with each other.

In another embodiment, the standard deviation of the combined smoothed flow output is about or less than 0.005.

In another embodiment, the method comprises curing said deposited material with ultraviolet light.

In another embodiment, the method comprises controlling intensity of radiation from said radiation source and/or position of said radiation source according to one or more of:
a) material properties of said material,
b) output flow rate from said dispensing head,
c) print resolution requirements,
d) requirements for overhangs,
e) requirements for full density structures.

In a second aspect, the present invention relates to apparatus for three-dimensional printing of three-dimensional objects comprising:
at least one reservoir configured to store at least one material for printing three-dimensional objects,
at least one material dispensing head in fluid connection with said reservoir,
   one or more peristaltic pump(s) controlling transport of said material from said reservoir to said material dispensing head, each said peristaltic pump comprising rollers driven by a motor to periodically compress a pump tubing to move material through said pump tubing,
a control system controlling operation of said motor of each peristaltic pump,
a radiation source for curing said material once dispensed from said dispensing head,
wherein said material is a photopolymer.

In one embodiment, said photopolymer material is a viscous fluid at ambient temperature, wherein said material exhibits shear thinning and/or thixotropy, such that said material undergoes minimal flow between deposit and curing.

In another embodiment, the apparatus is for manufacturing three-dimensional objects including plurality of materials, wherein the apparatus comprises a plurality of reservoirs for storing each material.

In another embodiment, the apparatus is for manufacturing three-dimensional objects including a plurality of materials, wherein the different materials are sequentially printed, and wherein one or more of:
a) said reservoir,
b) said pump tubing inside said peristaltic pump(s),
c) fluid connection(s) between said reservoir and said peristaltic pump(s),
d) fluid connection(s) between said peristaltic pump(s) and said dispensing head,
e) a dispensing nozzle of said dispensing head,
is/are replaceable for use with said second material when substituting materials.

In another embodiment, the apparatus comprises one or more of:
a) multiple dispensing heads,
b) automatically or manually swappable dispensing head(s),
c) a replaceable dispensing nozzle in said dispensing head.

In another embodiment, said control system receives positional data related to said motor(s) of the peristaltic pump(s), and wherein the control system varies the speed of rotation of the motor(s) to maintain a desired output flow rate from said peristaltic pump(s).

In another embodiment, said control system increases the speed of rotation of each motor at intervals where the pump tubing is uncompressed by said rollers, such that the pulsatility of the flow output from said peristaltic pump(s) is smoothed, and said desired output flow rate is maintained.

In another embodiment, each pump is driven by a stepper motor, wherein said pump(s) and control system are calibrated by:
a) characterizing flow output of each peristaltic pump by determining periods of reduced flow,
b) determining one or more compensation parameters as the increase in the steps of said stepper motor required to maintain flow output during said periods of reduced flow,
wherein said compensation parameter(s) is applied to said peristaltic pump(s) via said control system to increase the steps of said stepper motor during said predetermined periods of reduced flow as characterized, such that a desired output flow rate from said peristaltic pump(s) is maintained.

In another embodiment, the apparatus comprises multiple pumps connected in parallel with each other,
wherein each pump transports material from said reservoir to said dispensing head, and
wherein the pumps operate out of phase with each other.

In another embodiment, the apparatus comprises two pumps operated 30 degrees out of phase with each other.

In another embodiment, the absolute position of said stepper motor of each pump is tracked, such that the pumps may be maintained of phase with each other.

In another embodiment, the standard of the smoothed flow output is about or less than 0.005.

In another embodiment, said radiation source is an ultraviolet light source.

In another embodiment, said ultraviolet light source comprises one or more ultraviolet light emitting diode(s) positioned on said dispensing head.

In another embodiment, the apparatus comprises multiple ultraviolet light emitting diodes positioned in rotational symmetry around a dispensing nozzle of said dispensing head.

In another embodiment, intensity of radiation from said radiation source and/or position of said radiation source is/are controllable.

In another embodiment, one or more of said reservoir(s), dispensing head(s), fluid connection between said reservoir(s) and pump(s), fluid connection between said pump(s) and dispensing head(s) is/are shielded from said radiation source.

In another embodiment, the apparatus is used to:
a) print one or more smart materials, and/or
b) integrate one or more smart components within a printed three dimensional object.

In another aspect, the present invention relates to a method of reducing pulsatility of flow output from one or more peristaltic pump(s) to maintain a desired output flow rate, wherein each said peristaltic pump comprises rollers driven by a motor to periodically compress a pump tubing to move material through said pump tubing, the method comprising:
transmitting positional data related to said motor of each peristaltic pump to a controller,
varying the speed of rotation of said motor via said controller to maintain said desired output flow rate from said peristaltic pump.

In one embodiment, said control system increases the speed of rotation of each motor at intervals where the pump tubing is uncompressed by said rollers, such that the pulsatility of the flow output from said peristaltic pump is smoothed, and said desired output flow rate is maintained.

In another embodiment, each peristaltic pump is driven by a stepper motor, the method further comprising calibration steps of:
characterizing flow output of each peristaltic pump by determining periods of reduced flow,
determining one or more compensation parameters as the increase in the steps of said stepper motor required to maintain flow output during said periods of reduced flow,
wherein said controller applies said compensation parameter(s) to each pump to increase the steps of said stepper motor during said predetermined periods of reduced flow as characterized, such that said desired output flow rate from said peristaltic pump is maintained.

In another embodiment, the method further comprises driving multiple peristaltic pumps in parallel with each other to generate a combined flow output,
wherein said pumps are operated out of phase with each other, and
wherein said compensation parameter(s) is/are applied to each pump, such that a desired combined output flow rate is maintained.

In another embodiment, the method is used to control transport of material from a reservoir to a material dispensing head of a three-dimensional printing apparatus via one or more peristaltic pump(s).

The term “comprising” as used in this specification and claims means “consisting at least in part of”. When interpreting each statement in this specification and claims that includes the term “comprising”, features other than that or those prefaced by the term may also be present. Related terms such as “comprise” and “comprises” are to be interpreted in the same manner.

This invention may also be said broadly to consist in the parts, elements and features referred to or indicated in the specification of the application, individually or collectively, and any or all combinations of any two or more said parts, elements or features, and where specific integers are mentioned herein which have known equivalents in the art to which this invention relates, such known equivalents are deemed to be incorporated herein as if individually set forth.

The invention consists in the foregoing and also envisages constructions of which the following gives examples only.

### BRIEF DESCRIPTION OF THE DRAWINGS

Preferred embodiments of the invention will be described by way of example only and with reference to the drawings, in which:

FIG. 1 is a schematic illustrating the 3D printing apparatus according to one embodiment,

FIG. 2 is a perspective view of main components of the 3D printing apparatus according to one embodiment,

FIG. 3 is an exploded view showing the pump housing and pumps of the 3D printing apparatus according to one embodiment,

FIG. 4 is an exploded view of a dispensing head assembly of the 3D printing apparatus according to one embodiment,

FIGS. 5a and 5b show front and side elevations of the dispensing head assembly of FIG. 4,

FIG. 6 is a schematic illustrating the pump control system according to one embodiment, and

FIG. 7 is a graph comparing the smoothness of the flow output of a single pump, two pumps out of phase, and two pumps compensated according to the compensation method according to one embodiment.

### DETAILED DESCRIPTION OF PREFERRED EMBODIMENTS

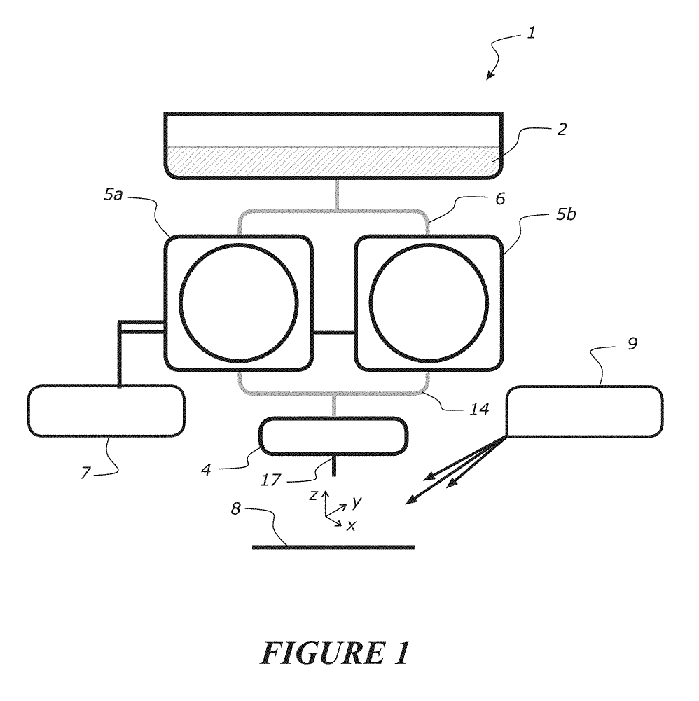

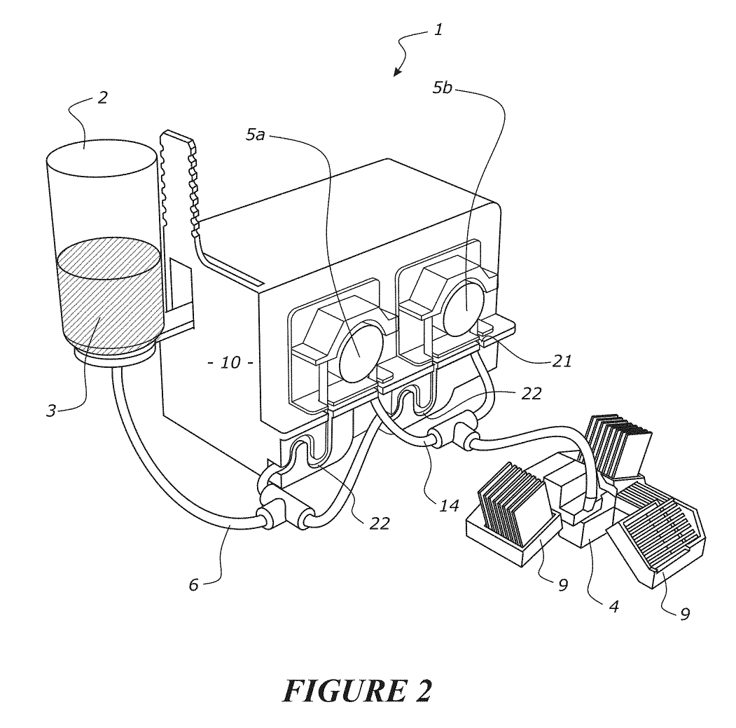

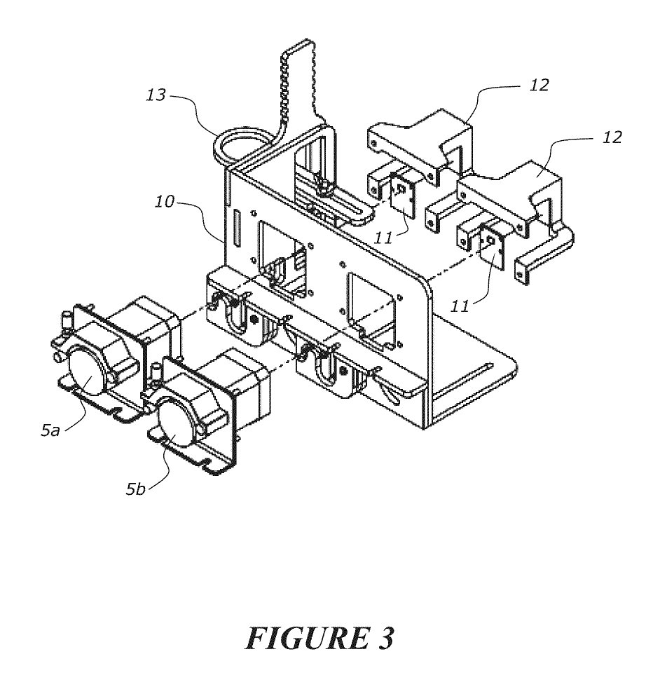

FIGS. 1 and 2 illustrate 3D printing apparatus according to a preferred embodiment. The apparatus 1 comprises a reservoir 2 which is configured to store material 3 for 3D printing. Material dispensing head assembly 4 is in fluid connection with the reservoir 2. As known in the art, material dispensing head is controllably movable (e.g., along Cartesian axes as schematically illustrated) to deposit material according to print instructions. Operation of the material dispensing head 4 (e.g., movement and dispensing rate) may be controlled by a control system (not shown) according to associated software for reading and executing instructions from 3D printing files, as known in the art.

One or more peristatic pumps 5a, 5b control the transport of the material from the reservoir 2 to the material dispensing head 4. The material 3 may then be dispensed, e.g. via a dispensing nozzle 17, onto a printing support/platform 8. Pump control system 7 controls the operation of the peristatic pump(s) 5a, 5b.

The material 3 is a photopolymer which is cured, once dispensed onto the printing platform 8, via a radiation source(s) 9. Photopolymers are known in the art, and comprise one or more photo-initiators which react with photons from the radiation source, resulting in polymerisation of the photopolymer and a change in material properties from a viscous fluid to a solid.

Preferably, the entire 3D printing process is performed at or near ambient temperatures. Accordingly, the photopolymer material 3 is not heated, and remains at substantially ambient temperature throughout the 3D printing process. The material properties of the photopolymer are preferably chosen to be independent of temperature and to allow for ease of transport through the system, while ensuring that the viscosity of the material at the dispensing head is suitable for the particular printing application.

The material is preferably sufficiently viscous to retain its shape after being deposited and while it is being cured, to retain the required high print resolution. For example, the material 3 may have a paste-like viscosity, e.g., similar to toothpaste. The use of peristaltic pumps 5a, 5b is particularly suited to the transport of such viscous material.

Further, it has been found that the use of high viscosity material allows for a comparatively high print speed while maintaining comparatively high print resolution. This has been found to be particularly useful for applications requiring relatively large, macro-scale objects to be printed, where these objects also include smaller scale, high-resolution details.

Another advantage found is in the manufacture of object shapes that lend themselves to “freeform” printing, e.g., lengths of filaments and other self-supporting structures, which allows for faster print speed and finer resolution of the printed object.

The present apparatus and methods have the capability to print different objects, each having a different structure as described above, and/or objects with mixed structures, i.e., combining freeform, macro-scale, micro-scale, and/or fine resolution parts within the printed object. This is in part due to the ability to handle substantially viscous materials, and additionally due to the ability to swap materials and associated component parts easily and cleanly, as will be discussed in more details below.

In other examples, the photopolymer material may be a Bingham pseudo-plastic fluid, which exhibits shear thinning and thixotropy. In this case, the material 3, when stored in the reservoir 2, may be quite viscous, but viscosity decreases to a substantially flowable fluid as the material is pumped through peristatic pumps, 5a, 5b, to arrive at dispensing head 4.

One major advantage of keeping the 3D printing process at substantially ambient temperature is the ability to print heat-sensitive materials or components. Accordingly, in some embodiments, the present methods and apparatus may be used to 3D print “smart” materials or components, such as sensors, actuators, piezoelectric elements, smart polymers, MEMS components, etc.

In other embodiments, the present methods and apparatus may be used integrate smart components or materials into a macro-scale object in a single printing process.

To print smart materials and/or integrate smart components into printed objects, the apparatus may be configured to print more than one material. The apparatus, including reservoirs 2, pumps 5, dispensing heads 4 may be scaled as required to allow for different materials to be deposited onto the printing platform 8 on demand. The amount, type, and deposit order of the polymer may be specified as required, to produce a customized, multi-material object.

Accordingly, in some embodiments, the apparatus may comprise more than one set of reservoir 2, pump 5 and dispensing head 4, each set of components configured to store, transport and dispense a single type of material.

In another embodiment, different materials are dispensed sequentially onto the printing platform 8, resulting in a final product composed of multiple materials. For this embodiment, the relevant components of the apparatus may be substituted as required throughout the printing process.

For example, any one or more of reservoir 2, the fluid connection 6 between the reservoir and the pump, the fluid connection 14 between the pump and the dispensing head, dispensing nozzle 17 inside dispensing head assembly 4, may be replaced with a different set of the respective components (in order to be used with a different material), when it is required to swap materials. To this end, the use of peristatic pumps provides the benefits of easy replaceability, cost-effective parts, and non-contamination/non-mixing of the materials that are transported through the pump.

These advantages of peristatic pumps also apply to another envisaged application of the present apparatus and methods for rapid prototyping and one-off, customised printing. The ability to 3D print small prototyping or production runs of customised devices presents a significant market advantage.

For example, constructing MEMS devices typically requires a high upfront cost for the specialised equipment and tooling required for the MEMS-scale sensors and actuators. Once the specialised equipment and tooling has been developed, there is typically very little flexibility in further customisation of the machinery and processing. Accordingly, the ability to 3D print customized MEMS devices in small batches, while allowing for further development of the prototype, provides a low cost and effective prototyping solution.

The use of peristatic pumps allows for convenient, cost-effective and quick interchanging of material supply chain components when swapping materials for different production runs, essentially requiring only a change of the peristatic pump tubing instead of a change of the entire pump/transportation system. Since the material 3 is entirely contained within the tubing from reservoir 2 to dispensing head 4, there is no risk of cross-contamination.

Further, peristaltic pumps 5a, 5b allow for connection to a larger reservoir of fluid, e.g., reservoir 2. Accordingly, additional material may be added to the reservoir(s) at any time during a printing procedure, ensuring no print failure issues due to material shortage.

In one embodiment, the pump housing 10 may be configured to simplify the replacement of the peristaltic pump tubing. For example, S-bend 22 and pinch clamps 21 on the pump housing as shown in FIG. 2 are configured to hold the length of peristaltic pump tubing 23 in place and prevent movement during operation.

Further, this configuration enables the length of tubing 23 to be isolated from fluid connection 6 (between the reservoir and the pump), and the fluid connection 14 (between the pump and the dispensing head), allowing the peristaltic tubing 23 to be easily and cleanly replaced.

However, one disadvantage of using a peristatic pump is the pulsatile flow output. As known in the art, peristatic pumps operate by periodically compressing a tube against the housing of the pump to move fluid through the tube. Specifically, the rotor of the pump motor comprises multiple rollers or lobes which push the tubing against the housing. This repetitive sequence causes the pulsatile flow output. The number of compressions of the tube (and hence the number of pulses in the flow output) in every rotation of the pump rotor depends on the number of rollers provided to the pump.

As will be appreciated, the material 3 should be delivered to the dispensing head in a smooth flow and at a desired output rate, to ensure continuity of the printed object. The effect of pulsatile flow is especially noticeable when printing at small (e.g., MEMS-scale) resolution.

To address this issue, the present apparatus 1 and methods utilise peristaltic pump(s) which is/are driven by motor(s) which allow for precise position control. The control system 7 receives position feedback related to the motors and applies a compensation procedure to the motor to smooth the output of the peristaltic pumps 5a, 5b, thus ensuring that the desired output flow rate is achieved. It is envisaged that motors such as stepper motors, servomotors, piezoelectric motor, etc., which allow for precise control of rotation may be used. Alternatively, the position of the motor may be tracked and controlled using rotary encoders.

Essentially, the compensation procedure applied by the control system speeds up the rotation of the motor during the periods where the roller breaks contact with the pump housing (which results in expansion of the pump tubing and reduction in flow output). As a result, the flow output is maintained at a more constant volume even during these periods, resulting in a substantially constant flow rate.

In one embodiment, the pump is calibrated for this compensation procedure by firstly characterising the flow output of the pump 5, in particular, determining the periods of reduced flow in each cycle of the rotor. The typical flow output pattern of peristaltic pumps comprise periods of constant flow rate broken up by an abrupt reduction in flow (or even reverse flow—see, e.g., Table 1) where the peristatic tube is allowed to expand between compressions. During these periods of reduced flow, if the motor driving the pump is sped up a corresponding amount, e.g., the steps of the stepper motor are increased, the pump output can be substantially maintained.

Accordingly, the increase in the steps of said stepper motor required to substantially maintain flow output during the characterized periods of reduced flow is determined and defined as the compensation parameter for the pump. In some cases, the required increase in the number of steps may be variable over the period of reduced flow, such that a compensation scheme is required.

The compensation procedure is then applied by the control system 7 when operating peristaltic pump. That is, during the periods where the pump would originally have generated reduced flow output, the stepper motor is sped up. As a result, the compensated pump demonstrates significantly better regulation of the volume output delivered for every rotation of the rotor, and consistently delivers the desired material output rate to the print head.

In one embodiment, the apparatus 1 comprises more than one peristaltic pump, operating parallel to each other to transport material from the same reservoir 2 to the same dispensing head 4. The pumps are configured to operate out of phase with each other, which further helps to smooth the pulsatile effect on the flow.

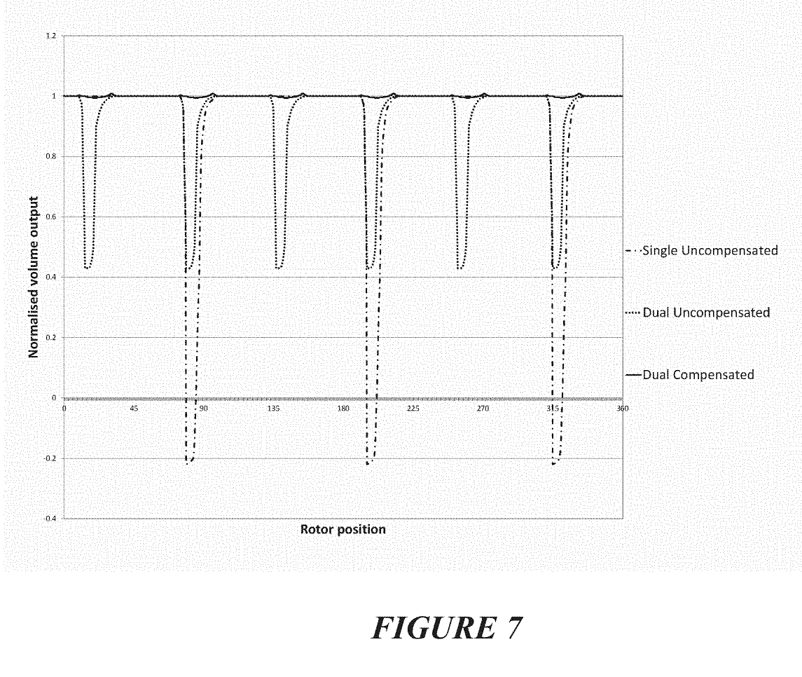

For example, the apparatus 1 may comprise two peristaltic pumps 5a, 5b operating parallel with each other as illustrated in FIGS. 1 and 2. Each pump may comprise three rollers, such that with every cycle of the rotor, each individual pump generates three dips/reduction in flow output. This is shown in the graph of FIG. 7. The pumps may be configured to operate 30 degrees out of phase with each other (i.e., the motors are set at 30 degrees out of phase with each other at start-up). The resulting combined flow output, as shown in the graph of FIG. 7, demonstrates double the frequency of dips per cycle; however these are much smaller (approximately half) in amplitude.

To set the pumps out of phase with each other, a method of tracking the position of the motors 29a, 29b is required. In one example, magnetic rotary encoders 11 may be affixed to the rear of each pump 5a, 5b, allowing for feedback of absolute position to the pump controller 24. It will be appreciated that other sensors may be used for providing angular position feedback, e.g., optical, inductive, capacitive encoders. In other embodiments, the peristaltic pumps may employ servomotors or other closed loop motors with positional feedback to maintain the pumps out of phase with each other.

In other embodiments, the absolute position of the motors may be stored in controller memory, but this may be less desirable due to processing time and the limited number of write cycles available for non-volatile memory. Further, in the event that the system is powered down, the last known position would be lost.

In a preferred embodiment, to further increase the smoothing effect, the compensation procedure described above is applied to each of the multiple pumps 5a, 5b connected in parallel but operating out of phase with each other. The effect of the compensated combined flow output, as shown in the graph of FIG. 7, is much smoother compared to the uncompensated pump arrangements. For the compensation procedure, each pump was driven at a higher speed (i.e., stepper motor steps incremented) during the predetermined periods of reduced flow as characterized for each pump. Because it takes a finite amount of time to increment the steps of the motor/increase the speed of the rotor, the use of two (or more) pumps out of phase with each other helps to compensate for this time delay.

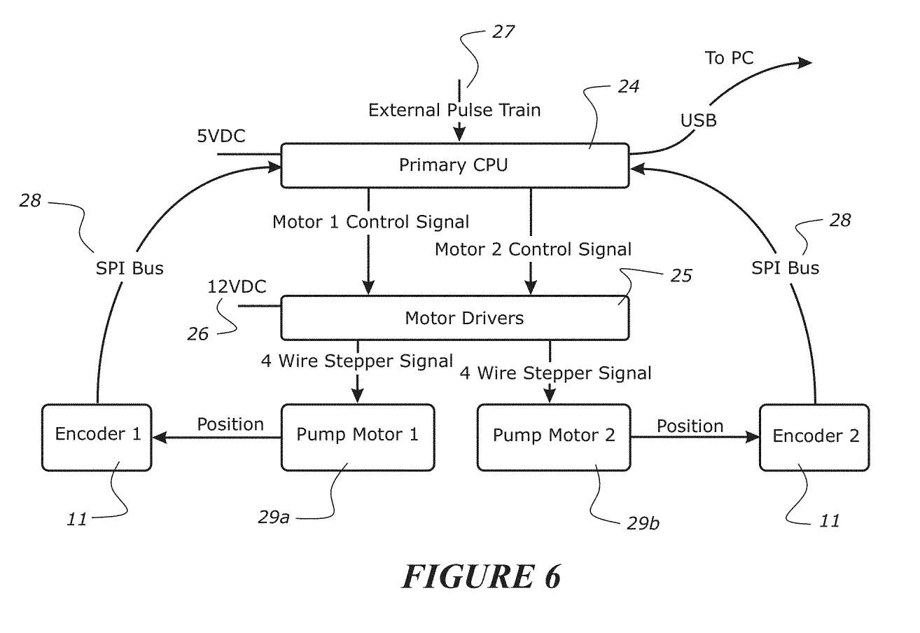

Table 1 compares the standard deviation of the flow output as determined from experiments with a single pump, a dual pump setup and a compensated dual pump setup. Standard deviation was calculated from flow output values obtained at each step of the motor(s) (in these trials, the motor(s) was/were stepped 800 times per revolution, as discussed in more detail below). Accordingly, the standard deviation provides a measurement of the variability of flow from a constant flow rate. The compensated dual pump arrangement exhibited minimal variation in flow output, with a negligible standard deviation of 0.0029. The pump(s) used in these trials were Kamoer KSC-B16SB3A three-roller peristaltic pumps, controlled according to the compensation control scheme as illustrated in FIG. 6.

TABLE 1

| | Single | Parallel | Compensated |
|---|---|---|---|
| Pump arrangement | pump | dual | dual |
| Standard deviation of | 0.28 | 0.16 | 0.0029 |
| output flow | | | |
| Reverse flow | Yes | No | No |

FIG. 6 illustrates one embodiment of the pump control scheme for driving two peristaltic pumps 5a, 5b. In one embodiment, the pumps and control system are designed to function as a standalone unit, requiring only a power supply 26 and a pulse train 27 to operate, the rising edge of the pulse signalling a step. Stepper motor drivers 25 drive the stepper motor of each pump. A dedicated controller 24 controls the operation of each pump, including handling the stepping of the pump motors 29a, 29b, reading of the encoders 11, serial communication and integration with other systems. Positional feedback from the encoders 11 may be read by the controller 24 by connecting the two encoders 11 in parallel over a Serial Peripheral Interface (SPI) bus 28.

In this embodiment, the controller acts as a virtual stepper, providing the minimum delivery of material per rising edge of an input pulse train 27. This advantageously allows any pre-driver stepper signal to be fed directly into the pump controller, and hence allows immediate integration of the pump system with any available 3D printing platforms. The design of the pump assembly with associated firmware as a standalone unit allows it to be readily integrated with other systems to extrude on demand, with all pump compensation procedures accounted for by the on-board firmware.

In some embodiments where stepper motors drive the pumps, microstepping may be used to increase the resolution of each motor 29a, 29b. Microstepping moves the stator flux of a stepper motor more smoothly by driving the coils with a waveform, increasing the resolution of the rotation, but at the expense of available torque and step size accuracy. In one embodiment utilising Kamoer KSC-B16SB3A peristaltic pumps with a resolution of 200 steps per cycle, a microstepping factor of ¼ was found to be a suitable reduction for the loaded motors, increasing the number of steps available per revolution to 800 for each motor.

Once the material 3 has been deposited onto the printing platform 8, the material is cured by the radiation source. Preferably, the photopolymer 3 is cured by exposure to UV light and the radiation source is accordingly, an ultraviolet (UV) light source.

In some embodiments, the ultraviolet light source comprises one or more ultraviolet light emitting diode(s) (LEDs) positioned on the dispensing head 4.

Various other configurations and positioning of the LEDs may be suitable, provided the arrangement allows for the deposited material to be substantially evenly radiated, and can provide a sufficiently intense dose to ensure sufficient curing of the material only once deposited (e.g., the light is preferably not directed at the dispensing nozzle, which could cause a blockage of the nozzle).

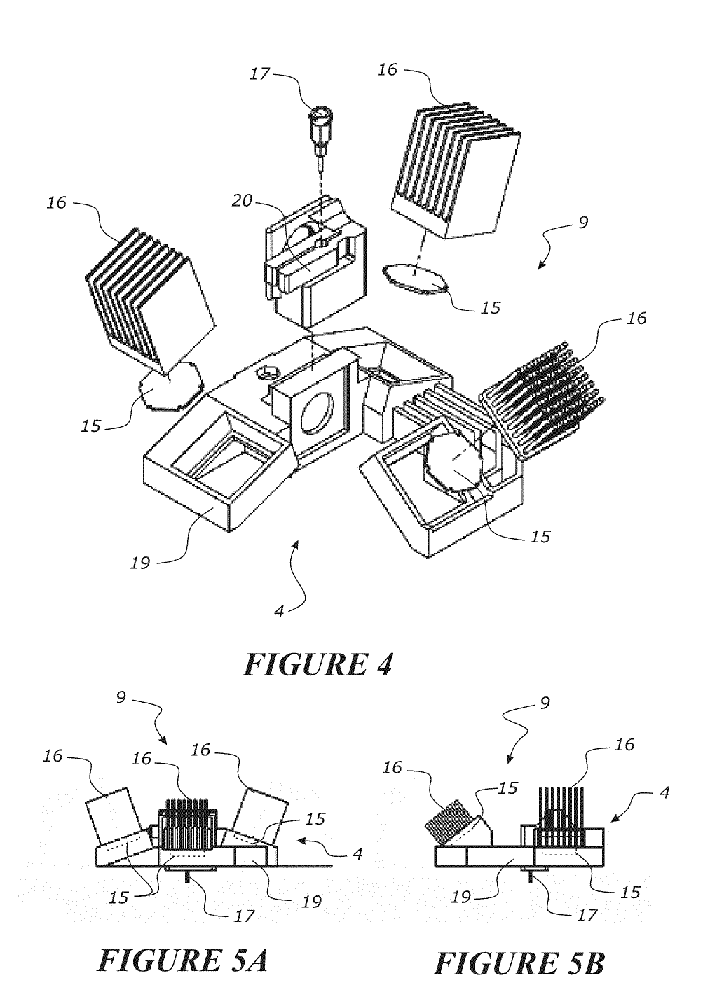

In the embodiment shown in FIGS. 4 and 5, LED mount 19 is configured to position three UV LEDs around the nozzle mount 20 of the dispensing head. Preferably, these are arranged in rotational symmetry around the dispensing nozzle 17, to ensure substantially even radiation of the printed object. Heat sinks 16 may be provided to each LED.

In other embodiments, the intensity of the radiation from said radiation source and/or the position of said radiation source may be controllable by the user/software depending on the requirements for the specific print application. For example, this may depend on properties of the material 3, the rate of deposition, the print resolution required, any requirements for overhangs (which would require very fast curing) or conversely any requirements for slower curing, to allow fluid to spread to fill the gaps in the structure and produce full density structures.

For example, a UV laser may be used to provide a more accurate, controllable curing method. The high intensity and accuracy of the laser could allow for a reduction in the spreading of the fluid as it makes contact with the build material by curing the extrusion faster than it can spread, thus increasing the resolution of the print. The laser beam would preferably be directed along the path of the extrusion or deposition of the material, and would therefore need to be movable according to trajectory of the dispensing head 4.

Preferably, the components containing the photopolymer (e.g., reservoir(s), dispensing head(s), fluid connection between said reservoir(s) and pump(s), fluid connection between said pump(s) and dispensing head(s)) are shielded from the radiation source, to ensure that curing only occurs where required. For example, the tubing and fluid connections are preferably opaque to shield from UV light.

The foregoing description of the invention includes preferred forms thereof. Modifications may be made thereto without departing from the scope of the invention as defined by the accompanying claims.

What is claimed is:

1. A method for printing three-dimensional objects comprising:
providing at least one material for printing three-dimensional objects in at least one reservoir,
transporting said material from said reservoir to at least one material dispensing head via one or more peristaltic pump(s), each said peristaltic pump comprising rollers driven by a motor to periodically compress a pump tubing to move said material through said pump tubing, wherein said motor is controlled by a control system,
depositing said material from said dispensing head, and
curing said deposited material with radiation.

2. The method of claim 1, wherein the entire printing method is performed at ambient temperature.

3. The method of claim 1, for printing three dimensional objects including a plurality of materials, the method further comprising providing multiple materials from multiple reservoirs, and transporting each material to a different dispensing head via one or more peristaltic pump(s).

4. The method of claim 1, for printing three dimensional objects including a plurality of materials, the method further comprising:
providing a first material from said reservoir,
transporting said first material from said reservoir to said material dispensing head via said peristaltic pump(s),
depositing said first material from said dispensing head,
curing said deposited first material with radiation,
providing a second material from said reservoir or from a second reservoir,
replacing one or more of:
a) said pump tubing inside said peristaltic pump(s),
b) fluid connection(s) between said reservoir and said peristaltic pump(s),
c) fluid connection(s) between said peristaltic pump(s) and said dispensing head,
d) a dispensing nozzle of said dispensing head,
for use with said second material,
transporting said second material from said reservoir or said second reservoir to said material dispensing head via one or more peristaltic pump(s),
depositing said second material from said dispensing head, and
curing said deposited second material with radiation.

5. The method of claim 1, wherein said control system receives positional data related to said motor(s) of the peristaltic pump(s), and wherein the control system varies the speed of rotation of the motor(s) by increasing the speed of rotation of the motor(s) at intervals where the pump tubing is uncompressed by said rollers, to maintain a desired output flow rate from said peristaltic pump(s).

6. The method of claim 5, wherein each peristaltic pump is driven by a stepper motor, the method further comprising calibration steps of:
characterizing flow output of each peristaltic pump by determining periods of reduced flow,
determining one or more compensation parameters as the increase in the steps of said stepper motor required to maintain flow output during said periods of reduced flow,
wherein said control system applies said compensation parameter(s) to each pump to increase the steps of said stepper motor during said predetermined periods of reduced flow as characterized, such that a desired output flow rate from each peristaltic pump is maintained.

7. The method of claim 5, wherein material from said reservoir is transported to said material dispensing head via multiple pumps connected in parallel with each other,
wherein each pump transports mate a from said reservoir to said dispensing head, and
wherein the pumps operate out of phase with each other.

8. The method of claim 7, wherein each peristaltic pump is driven by a stepper motor, and wherein the method further comprises tracking the absolute position of the stepper motor of each pump, to maintain the pumps out of phase with each other.

9. The method of claim 1, comprising curing said deposited material with ultraviolet light.

10. The method of claim 1, comprising controlling intensity of radiation from said radiation source and/or position of said radiation source according to one or more of:
a) material properties of said material,
b) output flow rate from said dispensing head,
c) print resolution requirements,
d) requirements for overhangs, and
e) requirements for full density structures.

11. An apparatus for three-dimensional printing of three-dimensional objects comprising:
at least one reservoir configured to store at least one material for printing three-dimensional objects,
at least one material dispensing head in fluid connection with said reservoir,
one or more peristaltic pump(s) controlling transport of said material from said reservoir to said material dispensing head, each said peristaltic pump comprising rollers driven by a motor to periodically compress a pump tubing to move material through said pump tubing,
a control system controlling operation of said motor of each peristaltic pump, and
a radiation source for curing said material once dispensed from said dispensing head,
wherein said material is a photopolymer.

12. The apparatus of claim 11, wherein said photopolymer material is a viscous fluid at ambient temperature, wherein said material exhibits shear thinning and/or thixotropy, such that said material undergoes minimal flow between deposit and curing.

13. The apparatus of claim 11 for manufacturing three-dimensional objects including a plurality of materials, wherein the different materials are sequentially printed, and wherein one or more of said reservoir, said pump tubing inside said peristaltic pump(s), fluid connection(s) between said reservoir and said peristaltic pump(s), fluid connection(s) between said peristaltic pump(s) and said dispensing head is/are replaceable when substituting materials.

14. The apparatus of claim 11, comprising one or more of:
a) multiple dispensing heads,
b) automatically or manually swappable dispensing head(s), and
c) a replaceable dispensing nozzle in said dispensing head.

15. The apparatus of claim 11, wherein said control system receives positional data related to said motor(s) of the peristaltic pump(s), and wherein the control system varies the speed of rotation of the motor(s) by increasing the speed of rotation of each motor at intervals where the pump tubing is uncompressed by said rollers, to maintain a desired output flow rate from said peristaltic pump(s).

16. The apparatus of claim 15, wherein each pump is driven by a stepper motor,
wherein said pump(s) and control system are calibrated by:
a) characterizing flow output of each peristaltic pump by determining periods of reduced flow,
b) determining one or more compensation parameters as the increase in the steps of said stepper motor required to maintain flow output during said periods of reduced flow, and
wherein said compensation parameter(s) is applied to said peristaltic pump(s) via said control system to increase the steps of said stepper motor during said predetermined periods of reduced flow as characterized, such that a desired output flow rate from said peristaltic pump(s) is maintained.

17. The apparatus of claim 15, comprising multiple pumps connected in parallel with each other,
wherein each pump transports material from said reservoir to said dispensing head, and
wherein the pumps operate out of phase with each other.

18. The apparatus of claim 17, wherein each peristaltic pump is driven by a stepper motor, and wherein the absolute position of said stepper motor of each pump is tracked, such that the pumps may be maintained of phase with each other.

19. The apparatus of claim 13, used to:
a) print one or more smart materials, and/or
b) integrate one or more smart components within a printed three dimensional object.

20. A method of reducing pulsatility of flow output from one or more peristaltic pump(s) to maintain a desired output flow rate, wherein each said peristaltic pump comprises rollers driven by a motor to periodically compress a pump tubing to move material through said pump tubing, the method comprising:
transmitting positional data related to said motor of each peristaltic pump to a controller, and
varying the speed of rotation of said motor via said controller by increasing the speed of rotation of each motor at intervals where the pump tubing is uncompressed by said rollers, to maintain said desired output flow rate from said peristaltic pump.
